(19) United States
(12) Patent Application Publication
(10) Pub. No.: US 2003/0229555 A1
(43) Pub. Date: Dec. 11, 2003

(54) Investment grade Shari'ah (Islamic) compliant financial product

(76) Inventor: Joanne Marlowe-Noren, Wadsworth, IL (US)

Correspondence Address: FOLEY & LARDNER, 321 NORTH CLARK STREET, SUITE 2800, CHICAGO, IL, 60610-4764, US

(21) Appl. No.: 10/295,087

(22) Filed: Nov. 15, 2002

Related U.S. Application Data
(60) Provisional application No. 60/387,766, filed on Jun. 11, 2002.

(51) Int. Cl. G06F 17/60

(52) U.S. Cl. 705/35

(57) ABSTRACT

A financial instrument formulated in accordance with the principles of the present invention comprises a traditional, rated, investment grade security in compliance with Shari'ah investment guidelines and Islamic law. This financial instrument can include an investment vehicle which is compatible and consistent with the operating morays and norms of the Western capital markets while complying with Shari'ah investment guidelines. The investment vehicle effectuates a passive or semi-passive investment by an individual or institution that observes Islamic law in the establishment of its investment criteria and the implementation of its investment practices. Further, the investment vehicle qualifies as a consistently formatted investment-grade, ratable security within a capital markets environment.

### FIELD OF THE INVENTION

The present invention relates to investment grade Shari'ah (Islamic) compliant financial products.

### BACKGROUND OF THE INVENTION

Historically, the Islamic versus non-Islamic investment philosophies have operated as wholly independent and virtually unrelated investment and finance systems for hundreds if not thousand of years. In Islamic economies, Shari'ah investment principles and religious guidelines are applied and practiced which are clearly understood by Islamic institutions and practicing Muslims. Shari'ah investment principles and religious guidelines refer to Islamic law related to financial and investment matters within the Islamic or Muslim community. Thus, Islamic economies have grown in strength by supporting Islamic projects and investments within the global Islamic community. Likewise, the investment banking, venture capital, and capital markets of the non-Islamic West have been well-served by operating solidly and consistently within their own respective financial markets. These Western financial markets have grown into a globally dominant force in respect of both financial strength and investment market volumes.

In today's global financial community, the financial stability, trade balances, national security, and market-driven interests of one country, financial market or region can, within moments, impact the stability, security and interests of another. It is thus desirable to level the proverbial investment “playing field” between respective divergent economic cultures that stand as independent fiscal and investment systems. The most prevalent example of the benefits of the creation of a vehicle or forum for the symbiotic coordination of Islamic investment philosophy with Western philosophy can be anticipated as a flow of Islamic investment capital into the mainstream Western economies by way of the institutional capital markets. It is this dynamic which has yet to be consistently achieved.

In addition, historically the Islamic investor has been either relegated to a very “hands-on” investment philosophy which requires virtually a project-by-project review of each and every investment in which it wishes to participate, against a backdrop of a traditional private placement. Alternatively, some degree of investment passivity has been afforded to the Islamic investor through the application of Islamic/Shari'ah compliant investment account structures as organized and managed by certain international or Islamic banking or financial institutions. Whereas a “hands-on” investment philosophy oftentimes does produce an attractive yield to the investor if the investor has been prudent in its detailed evaluation of the investment, the luxury of passivity in funds management customarily comes with a high price consisting of generally lower investment yields, making such a passive philosophy untenable and largely impracticable for a sophisticated investor. Therefore, in order to achieve stronger market returns, the Islamic investment community has generally been forced to maintain a very active hand in the structuring of its investment portfolios—a practice which is both time-consuming and expensive.

In the Western markets, strong, performing investment vehicles that can be easily defined and absorbed by the market without need for significant, investment-specific evaluation has been achieved in a variety of ways—the creation of municipal and corporate bond products, the issuance of collateralized notes, debentures, Variable Rate Demand Notes, the ready availability of Treasury Notes and Bonds, etc. Of note, however, is that none of these widely marketed investment vehicles complies with Shari'ah guidelines and is therefore disqualified from purchase by an individual, institution or entity which subscribes and abides by Islamic investment principles.

It is only in the relatively recent past that Islamic investment has penetrated portions of the non-Islamic Western economies by way of individual investments which have been effectuated by select “lead” institutions who have cultivated projects that could be individually made to comply with Shari'ah guidelines. Generally, the vehicle of choice has been in the form of specifically identified private placement transactions in which a given institution, one of either Islamic ownership or significant market presence within the Islamic community, has acted as a placement agent or otherwise to identify certain target investments. These target investments are identified with such particularity as to gain investor confidence in that particular project or investment as to be able to induce traditional and potentially higher risk, equity-based investment in that target project or investment. In such a case, the private placement would have necessarily been of significant merit and financial history as to gain investor confidence independent of any other third party considerations such as an investment grade rating (by an internationally recognized credit rating agency) of the financial instruments, investment units, securities or shares being placed or otherwise sold to candidate investors via the private placement. However, as with most private placements, such private placements are by their very nature customarily difficult to sell or otherwise place. In this type of scenario, numerous obstacles to the efficient investment of any substantial volume of Islamic funds exist, some of which are briefly examined below.

First, when one evaluates the nature of any private placement, generally, an investment that is handled in this manner lacks certain liquidity. Specifically, the securities have been acquired by the investor only as a result of close scrutiny and direct evaluation of the subject project's or investment's management, business plan, market particulars and financial data. This holds true whether the investor has acquired shares or stock, a debenture or bond of some type, or a hybrid investment unit which may combine certain characteristics of an equity investment with a debt instrument. Thus, the likelihood of the development of a secondary market for the securities acquired is extraordinarily slim, leaving the investor with little opportunity to exit the investment via a contingent route. In short, the type of investments normally managed via a private placement can differ dramatically in both credit terms and investment criteria from another potentially very similar project which may also have been structured via a private placement, such that there is little discernable or reliable market consistency from one investment to another. Under these circumstances, an investor has difficulty establishing a “common denominator” within its own portfolio such that a re-sale of the various securities acquired may be easily orchestrated with a third party investor, thereby denying or at minimum belaboring an easy and predictable exit from the investment (other than perhaps by liquidation upon declared default). Thus, the market tenor consists of a combination of lack of liquidity due to an unlikely development of a secondary market for the securities acquired and potentially detrimental exit parameters in the event of investment distress or project default. This market tenor is a significant deterrent to consistent and large-scale Islamic investment by way of traditional private placements.

Second, there are significant logistical considerations to effectuating a Shari'ah compliant investment, whether by private placement or otherwise. In order for an investment, company or project to be candidate for proper and compliant Islamic investment, the subject investment company or project must qualify for and have appointed to it a Shari'ah Supervisory Board (the “SSB”). The SSB is responsible for the on-going monitoring of the operations of the project, company or investment as to matters of Shari'ah compliance throughout the life of the Islamic investor's involvement in the investment. A properly structured and recognized SSB consists of three members: minimally two Islamic Scholars (as recognized by the Auditing and Accounting Office of Islamic Financial Institutions (the “AAOIFI”)) and a known and recognized expert in the field or industry of the subject investment, company or project. The SSB must not only approve the means by which the investor effectuates the investment, but must also thereafter actively oversee the operations of the subject investment in order to issue full Shari'ah compliance certification throughout the life of the investment. This permits the Islamic investor to rely upon the propriety of on-going Shari'ah compliance by the investment recipient. Based on the foregoing, it is reasonable to assume that each and every investment which is to be considered Shari'ah compliant requires the active involvement of at least two Islamic Scholars and potentially the nomination and review by the AAOIFI of a recognized expert to sit on the SSB with the Scholars. Beyond the obvious matter of managing the SSB once put in place for the benefit and certification of a subject investment, there is a very real matter of a true shortage of qualified and recognized Islamic Scholars which are available for this type of hands-on oversight and evaluation of candidate investments as a predicate to and as a post-script for every properly effectuated Shari'ah compliant investment. This is a significant factor in efficiently and properly establishing the compliance of a given investment opportunity consistent with Islamic investment principles.

Third, as stated earlier, the successful promotion and marketing of securities being offered by way of private placement generally reduces to an evaluation of the degree of likely success of the target investment based upon historical performance, present financial condition, management's perceived expertise and skills, market studies and extensive predictions as to long-term project feasibility by the investor. In order for such an evaluation to occur, the subject investment must be identified with great particularity prior to the completion of the placement of the securities, which subsequently becomes the source of investment to the target project. Therefore, generally, investments to be made by way of private placement suffer from the paradoxical dynamic of requiring an extensive operating history as the basis to make the offering potentially attractive to an investor. Yet such a strong operating history, if present, likely makes the project candidate for more simple and efficient approaches to raising the capital it proposes to seek via the private placement market. Such a dynamic oftentimes breeds inefficiencies in successfully placing an offering. These inefficiencies which are inherent in a private placement offering are subsequently compounded by the introduction of components required of the offering to assure Shari'ah compliance which makes Islamic investment readily practicable in the non-Islamic financial marketplace. Moreover, the approval process for a private placement is narrow and “case sensitive”, making any investment approval obtained obsolete except as to how it pertains to that particular and select project.

Lastly, the most significant issue which has hindered Islamic investments in the Western capital markets is rooted in the non-Islamic investment and business community's apparent lack of recognition, comprehension and practical accommodation of Shari'ah investment principles. As exemplified by the practice of facilitating Islamic investments in specific subject investments by means of private placement or equity mechanisms, there have been strides in certain investment banking environments to understand and accommodate Islamic investment requirements. These strides, however, are highly localized and specialized, contributing to the creation of an Islamic-friendly investment market within the Western theatre in only small pockets and within niche investment funds and structures. Thus far, there has been no institutionally scaled, consistently formatted Shari'ah compliant investment vehicle made available for purchase such that the luxury of a certain level of investor passivity can be fostered and perpetuated within the Islamic investment community.

At first glance, the significance and/or need for this type of passive, generic and consistent investment vehicle may not be readily apparent; however, it is as critical and elementary to the long-term stability and economic utilization of investment dollars arising from Islamic investors, just as the bond market is of critical import to the financial management philosophies of most institutionalized Western investors. To date, although a variety of traditional investment grade bond products, for example, exist in the Western capital markets which include features that underlie certain market-acceptable assurances of minimum principal value and fixed income features, no such large-scale, consistent investment grade security exists which caters to the Islamic investor and provides any such minimal investment value maintenance assurances.

What is thus needed is a financial instrument that can be applied in investment banking, private placement and capital markets for the purposes of promoting and facilitating the efficient sale and/or placement of equity and/or debt in support of certain projects, ventures, investments and/or investment funds. Such financial instrument should bridge the religious, cultural and investment criteria “gap” inherent in Islamic investor consideration of Western financial packages, investment opportunities and/or capital markets offerings. The financial instrument should make compatible what have customarily been viewed as vastly divergent and conflicting investment philosophies; those being, the faith-based, religious considerations of Islamic investors, which are requisite to considering the appropriateness of a certain investment under recognized Shari'ah guidelines prior to any weight being afforded to a profit-driven evaluation of the investment by the Islamic investor, and the traditional, yield models which form the cornerstone of non-Islamic and Western profit-driven investment and capital markets decisions. Such financial instrument should promote the free flow of Islamic investment capital into the Western economies by way of the institutional capital markets to create the type of market dynamic which enables volume institutional investment in Shari'ah compliant Western investments and projects. The financial instrument should give the Islamic investor the opportunity to earn an attractive yield in a passive investment forum, enable institutional/volume purchases of an investment unit without concern for violating religious principles which the investor holds dear, allow for an efficient evaluation of an investment opportunity put before it via the use of traditional credit rating mechanisms, and foster investment using a generally consistently formatted investment unit which fosters the development of a secondary market for the units thus affording certain investment liquidity to the investor.

### SUMMARY OF THE INVENTION

A financial instrument in accordance with the principles of the present invention can be applied in investment banking, private placement and capital markets for the purposes of promoting and facilitating the efficient sale and/or placement of equity and/or debt in support of certain projects, ventures, investments and/or investment funds. A financial instrument in accordance with the principles of the present invention bridges the religious, cultural and investment criteria “gap” inherent in Islamic investor consideration of Western financial packages, investment opportunities and/or capital markets offerings. A financial instrument in accordance with the principles of the present invention makes compatible what have customarily been viewed as vastly divergent and conflicting investment philosophies; those being, the faith-based, religious considerations of Islamic investors, which are requisite to considering the appropriateness of a certain investment under recognized Shari'ah guidelines prior to any weight being afforded to a profit-driven evaluation of the investment by the Islamic investor, and the traditional, yield models which form the cornerstone of non-Islamic and Western profit-driven investment and capital markets decisions. A financial instrument in accordance with the principles of the present invention promotes the free flow of Islamic investment capital into the Western economies by way of the institutional capital markets to create the type of market dynamic which enables volume institutional investment in Shari'ah compliant Western investments and projects. A financial instrument in accordance with the principles of the present invention gives the Islamic investor the opportunity to earn an attractive yield in a passive investment forum, enables institutional/volume purchases of an investment unit without concern for violating religious principles which the investor holds dear, allows for an efficient evaluation of an investment opportunity put before it via the use of traditional credit rating mechanisms, and fosters investment using a generally consistently formatted investment unit which fosters the development of a secondary market for the units thus affording certain investment liquidity to the investor.

A financial instrument in accordance with the principles of the present invention provides a basis by which the credit-worthiness of a subject Shari'ah investment can be measured in a manner consistent with generally accepted investment practices via the rating (by an internationally recognized credit rating agency) of the subject project, investment or fund. Specifically, the present invention creates a standardized platform for the regularized credit enhancement of a subject Shari'ah compliant project, investment or fund in keeping with Western economic norms such that high-volume, passive to semi-passive institutional investment may be cultivated and promoted within the international Islamic investment community for the benefit of the subject investment. The successful implementation of the present invention will bring to the Islamic investment community the ability to place full reliance upon impartial and recognized entities for the purposes of both credit evaluation and on-going Shari'ah compliance of the investment, thereby affording the Islamic investor with the fiscal luxury of necessarily conducting only a cursory review of each investment structured in accord with the principles of the present investment. That is to say, evaluation of the investment grade rating and the fatwa (compliance certification) issued by the SSB for financial instruments structured consistent with the principles of the present invention become the requisite tools for consideration of a subject investment. A financial instrument in accordance with the principles of the present invention provides for the creation of a far more manageable and efficient Islamic investment function than present practices permit.

A financial instrument formulated in accordance with the principles of the present invention comprises a traditional, rated, investment grade security in compliance with Shari'ah investment guidelines and Islamic law. This financial instrument can include an investment vehicle which complies with Shari'ah investment guidelines. The investment vehicle effectuates a passive or semi-passive investment by an individual or institution that observes Islamic law in the establishment of its investment criteria and the implementation of its investment practices. Further, the investment vehicle qualifying as investment-grade, ratable securities within a capital markets environment.

### BRIEF DESCRIPTION OF THE DRAWINGS

FIG. 1 is a methodological schematic overview of a subscription through yield payments process in accordance with the principles of the present invention.

FIG. 2 is a methodological schematic showing details of a subscription process in accordance with the principles of the present invention.

FIG. 3 is a methodological schematic showing payments, cash accounts and investment unit repurchase in accordance with the principles of the present invention.

FIG. 4 is a methodological schematic showing repurchase via utilization of guarantee in accordance with the principles of the present invention.

FIG. 5 is a methodological schematic showing Shari'ah compliant mechanisms in accordance with the principles of the present invention.

### DETAILED DESCRIPTION OF THE INVENTION

A financial instrument in accordance with the principles of the present invention effectively and diplomatically overcomes significant and well-recognized disadvantages to making investments by Islamic investors for the benefit of non-Islamic recipients, investments, projects and funds. When combined with tried-and-true capital markets philosophies and credit rating criteria, a financial instrument in accordance with the principles of the present invention enables the issuance and mass marketing of a Shari'ah (Islamic) compliant passive investment vehicle. This Shari'ah (Islamic) compliant passive investment vehicle can be acquired openly by Islamic institutions, non-Islamic Institutions with an Islamic division or holding, Islamic private investors as well as non-Islamic investors and institutions.

A financial instrument in accordance with the principles of the present invention enables the creation of an investment vehicle which, as supported by a series of specifically coordinated financial mechanisms, complies with Shari'ah Investment Guidelines. A financial instrument in accordance with the principles of the present invention enables the creation of an investment vehicle that functions as a means of facilitating or otherwise effectuating a passive or semi-passive investment by an individual or institution which observes Islamic law in the establishment of its investment criteria and the implementation of its investment practices. Of significance, the structuring of the Shari'ah compliant financial instruments in accordance with the principles of the present invention is designed and fiscally supported in such a way as to qualify as investment-grade, ratable (by Standard & Poor's, 55 Water Street, New York, N.Y. 10041 (“S&P”), Moody's Investors Service, Inc., 99 Church Street, New York, N.Y. 10007 (“Moody's”) or some other comparable credit rating agency) securities within a traditional “Westernized”, non-Islamic capital market environment. Thus, a financial instrument in accordance with the principles of the present invention establishes a standardized foundation upon which Islamic investors may stand and actively rely in order to enable the making of passive, direct and/or indirect investments in what, to date, has been considered a traditionally “Western” capital markets environment without any concern for violating any portion of Islamic law or Shari'ah investment principles. Moreover, a financial instrument in accordance with the principles of the present invention provides a basis for investment and fund management flexibility which, to date, has not existed in other Shari'ah compliant investment opportunities. Specifically, by employing a financial instrument in accordance with the principles of the present invention, the issuers are able to position their respective project, investment opportunity, investment portfolio or investment fund profile in such a way as to operate the project, opportunity, portfolio or fund in accordance with a generic investment criteria which would be disclosed to the candidate investors at the time of sale or placement of the financial instruments and enable the selection and underwriting of certain particular investments to occur at the discretion of the issuers even after the sale of the financial instruments to the investors.

A financial instrument in accordance with the principles of the present invention encompasses a variety of features that when brought together create a functional model which, both directly and indirectly, addresses and improves upon many of the issues raised in the previous section. Among other things, a financial instrument in accordance with the principles of the present invention combines the definable and consistent nature of a traditional, rated, investment grade security which the United States and other similarly formatted capital markets and non-Islamic Western bankers have benefited from for decades with the esoteric nature of an investment structure which hinges upon certain religious edicts of Islam that in themselves are difficult for non-Islamic parties to understand and appreciate. In fact, two of these edicts seem to fly in the face of some of the West's most common financial practices: the prohibition of collection of interest and the selection of subject investments based upon profitability rather than specific morality as measured against teachings of the Holy Qur'an. Such a core value combination of Islamic investment philosophy with non-Islamic investment mechanisms stands as the focal point of a financial instrument in accordance with the principles of the present invention.

The benefits of a financial instrument in accordance with the principles of the present invention, however, evidence a number of peripheral features and benefits to the financial instruments which make the financial products themselves unique in the capital markets and serve to highlight the technical complexities of accomplishing the implementation of these features in what is considered a Shari'ah (Islamic) compliant manner by accredited Islamic Scholars. Specifically, and in addition to the foregoing primary core improvement, the following features and key benefits of the financial instrument in accordance with the principles of the present invention:

the financial instruments are uniformly formatted amongst themselves such that a standardized security or financial instrument is created which need not materially vary based upon the underlying intended use of proceeds derived from the sale or placement of the financial instrument to the Islamic investor;

the financial instruments are ratable by a credit rating agency, thus raising placement efficiencies significantly and creating a foundation in the marketplace which is by nature conducive to the valuation and remarketing of the financial instruments (the conditions being right for the evolution of a standardized secondary market for the resale of the financial instruments), and thereby assuring some element of interim liquidity of the investment to the investor;

by way of certain repurchase covenants, the financial instruments have a minimum anticipated value at the conclusion of the investment term which is a contributing factor to the ratable nature of the financial instruments and which supports the likelihood of a contingent exit strategy for the investor by creating a “financial floor” to potential losses related to the investment, project or investment fund to which the proceeds of the financial instruments have or will be applied;

by way of the creation of a comprehensive general investment mechanism which is founded upon certain standardized investment eligibility requirements for the selection and implementation of a variety of underlying investments by the issuers of the financial instruments, Shari'ah supervision as to initial compliance of the financial instruments and, subsequently, functional and operational compliance of the subject investments is centralized within a single Shari'ah Supervisory Board, thereby increasing the overall efficiency and productivity of the Shari'ah Supervisory Board members;

the common thread of a single issuer and common Shari'ah Supervisory Board for a given financial instrument offering enables the creation of a composite investment portfolio which is comprised of a variety of different projects or investments, thereby effectively and inherently diversifying the risk to the Islamic investor and producing a more predictable overall projected yield on the financial instruments; and

the coordination of a variety of financial instrument offerings in support of vastly divergent investment criteria with potentially significantly varied projected yield curves provides an investment management tool to the Islamic investor which permits the investor to formulate its own projected blended rate of return by acquiring financial instruments arising from unrelated investments, projects, and investment funds that perform independently from each other, but yet share the same core terms and conditions as dictated by a standardized form of financial instrument, thus providing better underlying stability and investment consistency in the market.

The foregoing features demonstrate a clear and distinct advantage of a financial instrument in accordance with the principles of the present invention over the practices currently being utilized in relation to enabling Islamic investment in certain projects by building a basis of overall investment consistency which is modeled after the generally accepted investment vehicles of the Western capital markets. Such consistency produces an investment climate for the Islamic investor which is replete with more predictable base-line performance of the financial instruments, more easily appraised market valuations of the financial instruments, more traditionally evaluated creditworthiness of an offering and related financial instruments, more identifiable and measurable areas of specific risk related to the financial instruments, and more continuity and efficiency in Shari'ah compliance considerations between the financial instruments, the underlying investments and the interplay of the various parallel offerings amongst themselves. In all of the above examples, the common denominator is one of standardization and consistency in a Shari'ah (Islamic) compliant investment structure which fosters a regularization of the Islamic investment environment as it relates to and deals with broader investment opportunities of the West, whether or not they be of Islamic or non-Islamic origin.

### EXAMPLE

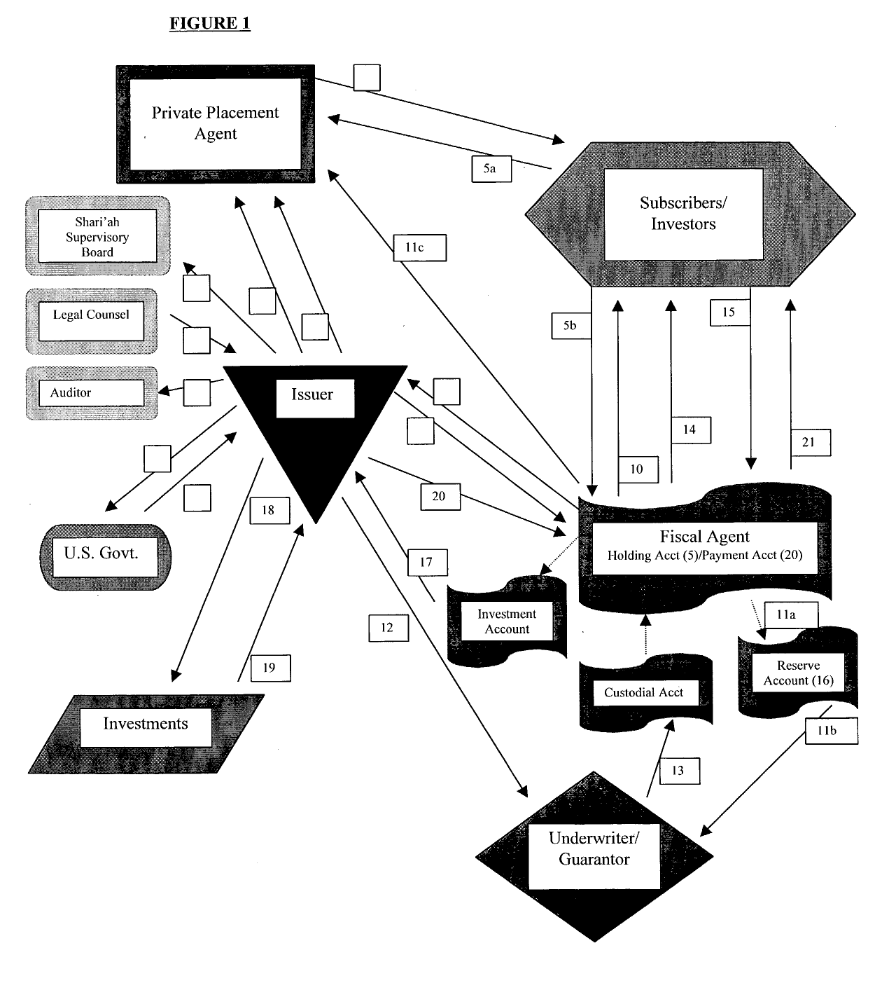

Referring first to FIG. 1, a methodological schematic depicting a general overview of a subscription through yield payments process in accordance with the principles of the present invention is seen. An entity is created or otherwise nominated (“Issuer”) who issues the financial instruments. In addition to issuing the financial instruments, the Issuer makes the offering for the purpose of attracting Islamic investment, and subsequently manages and implements the proceeds of the sale of the financial instruments in a manner consistent with the investment criteria established related to that certain offering. The Issuer creates a document that provides the potential investor with a required description of and disclosure related to the nature of the financial instrument being offered for sale (“Offering Memorandum”). The Issuer provides (101) the Offering Memorandum and supporting documentation to the Shari'ah Supervisory Board, and, as necessary, legal counsel and an Auditor for review and evaluation.

The Shari'ah Supervisory Board (the “SSB”) consists of two Islamic Scholars and an Islamic Banking expert, although, alternatively, it may consist of three Islamic Scholars and still meet the auditing requirements of the Auditing and Accounting Office of Islamic Financial Institutions (the “AAOIFI”) as the professional oversight entity for SSBs, among other things. The SSB reviews the Issuer's proposed financial instrument issuance strategy and is responsible for the monitoring of the Issuer's operations and the issuance of requisite certifications as to Shari'ah (Islamic) investment compliance throughout the life of the financial instruments. United States legal counsel reviews all offering documentation, issues required United States legal and tax opinions and provides legal assistance in relation to the operation of the Issuer as such goes to the facilitation of various investments. Foreign legal counsel incorporates the Issuer (as may be necessary in this example which calls for an Issuer of non-United States origin, although, in actual practice, the Issuer may be registered in any United States jurisdiction with no affect as to the operation of the present invention) and provides legal advice as to matters concerning the operation of the portfolios and administration of the operations of the Issuer in compliance with applicable foreign jurisdictional requirements, and issues requisite foreign legal and tax opinions required to complete the Offering Memorandum. The Auditor affords the Issuer with a comprehensive and Shari'ah (Islamic) compliant accounting body upon which the Shari'ah Supervisory Board and the investors may place reliance. The Auditor preferably should specialize in matters of Islamic finance.

As applicable, each of the aforementioned entities issues (102) its respective certifications and/or opinions in regard to the means by which financial instruments are made available for purchase to the investment marketplace (“Offering”). A complete description of the financial instruments proposed for issuance, and such certification and opinions are thereafter incorporated into the final Offering Memorandum.

The Offering Memorandum and all supporting documentation is tendered (103) by the Issuer to an agent (“Private Placement Agent”) for placement with qualified investors. The Private Placement Agent is responsible for the marketing of the offering and preferably should have a close association with the Islamic investment market. The Private Placement Agent markets (104) the Offering to qualified investors. The target market for the financial instruments consists of Islamic institutional investors (primarily banking and financial institutions), Islamic investment management funds, high net worth Islamic individuals and trusts and, to a lesser extent, non-Islamic investors (“Subscriber/Investor”).

The Subscriber/Investor provides (105a) advice of reservation for the financial instruments to the Private Placement Agent. In response to the reservation a Subscription Agreement defining the terms and conditions of the subscription of and investment in the financial instrument by the Subscriber/Investor is prepared, accompanied by a subscription package which details the terms and conditions of repurchase of the financial instruments by an international banking institution having a credit agency rating of sufficient quality to meet minimal rating criteria set forth by the nominated credit rating agency which rates the financial instruments (“Fiscal Agent”) or such other designated third party, as the case may be, from the Subscriber/Investor at an agreed value and at a future date not later than the redemption date of the financial instruments (the “Repurchase Agreement”).

The Subscriber/Investor executes and delivers (105b) the Subscription Agreement and corresponding fund origin warranties to, at the option of the Issuer, either the Private Placement Agent or the Fiscal Agent. In the present example, the Subscription Agreement is tendered to the Fiscal Agent. The Fiscal Agent acts as the administrator for the issuance of the financial instruments and a paying agent on behalf of the Issuer in favor of the investors. The Subscription Agreement and corresponding funds origin warranties are accompanied by a deposit of investment proceeds to a designated, non-interest bearing, depository account set up at the Fiscal Agent's institution having been designated for the receipt of proposed subscription proceeds prior to the Subscriber/Investor having been approved by the Issuer for purchase of the financial instruments (“Holding Account”).

An original copy of the Subscription Agreement and attachments are (106) provided to the Issuer by the Fiscal Agent for the purposes of the Issuer's evaluation and consideration of the Subscriber/Investor. The Issuer advises (107) the applicable United States Government agency of the proposed subscription to be made by a given Subscriber/Investor, seeking affirmation of the political and economic good standing of the proposed Subscriber/Investor. Provided the United States Government does not take issue with the quality or participation of a Subscriber/Investor, the Issuer receives (108) governmental consent to accept the subscription/investment proceeds and sell the financial instrument to the Subscriber/Investor.

Within a predefined period of receipt of subscription proceeds deposited to the Holding Account, the Issuer advises (109) both the Fiscal Agent and the Private Placement Agent of its acceptance of the Subscriber/Investor, and delivers an executed version of the Subscription Agreement to the Fiscal Agent signifying the Issuer's approval of the Subscriber/Investor. Upon receipt of the executed Subscription Agreement, the Fiscal Agent delivers (110) temporary certificates issued in favor of the Subscriber/Investor (“Temporary Global Certificates”) to the Subscriber/Investor, accompanied by the executed Subscription Agreement and all other related documents, and deposits the proceeds into a non-interest bearing depository account (“Proceeds Account”), signifying the good standing and acceptance of the subscription proceeds. The Temporary Global Certificates secure and represent subscription proceeds during that period of time while subscription proceeds are held in an account (“Reserve Account”) in support of the Temporary Global Certificates prior to the issuance of financial instruments by the Issuer (“Reserve Period”). The Reserve Account is a non-interest bearing, depository account or Shari'ah compliant investment account at the Fiscal Agent's or Underwriter/Guarantor's institution. At the discretion of the Issuer, an acceptably rated institution is designated for the establishment of the Reserve Account where proceeds shall be reserved, held and managed during the Reserve Period. Although it is preferable for the Reserve Account to be established with the Fiscal Agent, the Issuer may elect to establish the Reserve Account with the Underwriter/Guarantor institution as an added inducement or incentive to the Underwriter/Guarantor to participate as the guarantor for the Issuer by also permitting the Underwriter/Guarantor to provide certain Shari'ah compliant investment services related to the proceeds during the Reserve Period. The Temporary Global Certificates and the definitive financial instruments are Shari'ah (Islamic) compliant investment-grade securities to be issued and sold in accordance with the principles of the present invention.

Although not detailed herein, a Book-Entry Only System may be utilized as an alternative delivery method to the issuance of physical certificates for each of the Temporary Global Certificates and definitive Investment Units in accordance with the standard practices applied by the Depository Trust Company (“DTC”), Euroclear or other like entities or agencies.

For the purposes of fiscally supporting the Fiscal Agent's proposed repurchase of the financial instruments at the close of the term of the financial instruments, or rather that period between the date of subscription and the scheduled date of redemption of the financial instruments (“Investment Term”), an Underwriter/Guarantor is engaged for the issuance of its third party guarantee. The Guarantee is issued as the basis of credit enhancement of the Investment Units for the purposes of creating an investment grade security as interpreted by the credit rating agency. As a factor of Shari'ah compliance, the Guarantee is not technically a guarantee of fiscal performance of the Investment Unit itself, but rather a Guarantee of specific performance under the Repurchase Agreement.

Thus, it is the Issuer's proposed application of the subscription proceeds during the Investment Term that becomes the Underwriter/Guarantor's focus during the Guarantee underwriting process and continuing throughout the Reserve Period. Ultimately, what is achieved in order to cause the issuance of the Guarantee is the presentation of an artful balance. On the one hand, the design of the investment eligibility criteria for the investment portfolio should be broad enough to foster certain investment flexibility on the part of the Issuer. On the other hand, the design of an investment eligibility criteria for the investment portfolio should be specific enough to permit the Underwriter/Guarantor to be comfortable that the aggregate value of the Issuer's cash reserves and the subject investments' asset valuation will support a certain minimum investment portfolio valuation at the earliest possible date for draw on the Guarantee, which is the future date certain set for repurchase of the Investment Units by the Fiscal Agent at the conclusion of the Investment Term.

The formulation of an acceptable credit structure is accomplished with a candidate Underwriter/Guarantor by way of the negotiation and definition of: specific investment eligibility criteria which shall serve as the “blanket” investment policy of the Issuer and credit policy of the Underwriter/Guarantor related to the compilation of the investment portfolio (for solely the purposes of example, included in that eligibility criteria may be specific formulas which identify minimum required asset ratios when compared to total investment in a subject project, specific minimum historical performance ratios for a given candidate investment or project, required percentage-based cash reserve requirements which may be deposited with and held by the Underwriter/Guarantor during the life of a subject investment, the creation of a sinking fund to directly offset and compensate the Underwriter/Guarantor for the maximum perceived potential loss of asset value during the life of a given investment, the establishment of a minimum blended asset ratio to total funds invested); the establishment of an investment draw schedule during the Investment Term which may require certain minimum cash values be maintained on Issuer's accounts up to the date of scheduled Investment Unit repurchase; the allocation of a certain percentage of investment earnings, profits or yields arising from the Investments during the Investment Term into a dedicated Guarantee reserve account to be held by the Underwriter/Guarantor and drawable expressly by the Fiscal Agent in support of certain payments to be made by the Fiscal Agent under its Repurchase Agreement; the granting of a certain security interest in the accounts and assets of the Issuer in favor of the Underwriter/Guarantor; and/or the granting of a certain security interest in other additional collateral deemed acceptable to the Underwriter/Guarantor in support of the issuance of the Guarantee. The basis of negotiating and securing the Guarantee may include any one or more of the aforementioned mechanisms or such other mechanism as a specific Underwriter/Guarantor may warrant and a specific Issuer may grant. In any event, in securing the Guarantee the conservative formulation of an investment criteria is established which sufficiently supports the valuation of the Issuer's total available assets at the Investment Term, inclusive of the Investment Portfolio itself, such that the Underwriter/Guarantor may issue its Guarantee solely in support of the Fiscal Agent's performance on its repurchase undertaking to the Investors. The Underwriter/Guarantor is not being engaged for the purposes of guaranteeing specific performance of the Investment Units, lest the Guarantee be potentially deemed non-compliant with Shari'ah principles.

Additionally, to be Shari'ah compliant the Guarantee arises from an examination of the means by which the Underwriter/Guarantor may be compensated for the issuance of its Guarantee. An Underwriter/Guarantor is designated that may consist of a single international banking institution, one or more international banking institutions participating in a syndication or one or more insurance companies or reinsurers organized within a Shari'ah compliant performance guarantee mechanism or policy. In the case of the Underwriter/Guarantor as a banking institution having an acceptable investment grade rating, the credit rating of the Underwriter/Guarantor will become the basis by which the creditworthiness of the Investment Units is measured. In this example, the Guarantee takes the form of a letter of credit, preferably a standby letter of credit, which becomes payable upon default under the provisions of financial instrument repurchase or the Repurchase Agreement. Customarily, a banking institution will charge certain Issuance Fees related to the issuance of a letter of credit or similar undertaking. In order for the Guarantee to be and remain Shari'ah compliant, the Underwriter/Guarantor must agree to waive the collection of Issuance Fees related to the Guarantee, effectively issuing the letter of credit without consideration. Alternatively, the Underwriter/Guarantor instead can potentially profit in discounting the face value of the Guarantee upon issuance or by way of the exploitation of other potential revenue centers available to it related to the operations of the Issuer.

The foregoing generally identifies the specific performance obligation which is being supported by the Guarantee and the considerations which must be weighed in order to satisfactorily secure or otherwise collateralize and issue the Guarantee. These principles may be readily applied to a varied selection of Underwriters/Guarantors from both the banking and insurance industries in compliance with Shari'ah principles. In the preferred embodiment, the Underwriters/Guarantors operate within the banking industry. At the Issuer's option, however, an Underwriter/Guarantor may be engaged which consists of a single international banking institution, one or more international banking institutions participating in a syndication or consortium, one or more insurance companies or reinsurers organized within a Shari'ah compliant performance guarantee mechanism, surety or policy, or any combination of the above. However, in general, the use of a lead banking institution of sufficient credit quality (its credit rating according to S & P or Moody's being deemed of a certain investment grade) as an Underwriter/Guarantor is potentially the most efficient means of affecting the issuance of the Guarantee. In such case, the credit rating of the lead banking institution generally serves as the basis to enhance the rating of the financial instruments in order to meet the minimum rating criteria as defined by market-related conditions for the sale of the financial instruments. The lead Underwriter/Guarantor, at its option, may defray its risk by syndicating its participation via the “selling off” of portions of the obligation represented by the Guarantee to other banking or financial institutions.

Alternatively, the syndication process described above may be undertaken directly by the Issuer in the creation of a banking consortium for the issuance of multiple letters of credit which aggregate sum of their respective face values will total the par value of all outstanding Investment Units. All banking institutions participating in the consortium must have a certain minimum investment grade rating such that the credit rating agency may establish a blended rating for the financial instruments which is ultimately supported by the Guarantees to be issued by the consortium. Preferably, in the event that the Issuer organizes multiple Guarantees which shall support performance under the Repurchase Guarantee, all Guarantees should be issued concurrently such that the repurchase obligation of the Investment Units is viewed collectively and consistently as to operations and default provisions in the event of a default thereunder. Although potentially open to interpretation, the operation of all individual Guarantees concurrently assures certain parity between or equality among the outstanding Investment Units which is desirable.

As a further alternative, the Issuer could undertake to cause the engagement of one or more insurers or reinsurers, either individually or as a consortium, as the Underwriter/Guarantor(s) for the purposes of causing an acceptable Guarantee to be issued in the form of a performance guarantee policy or other Shari'ah compliant insurance or credit vehicle or even a letter of credit. Although this alternative is potentially successfully implemented by applying comparable underwriting, security or collateralization mechanisms to those profiled above and by negotiating an alternative means of compensating the Underwriter/Guarantor for the issuance of the required insurance or credit vehicle, as a matter of efficiency and consistency with Shari'ah principles as such relates to the Islamic view of the proper use and application of insurance, the utilization of an insurance mechanism appears to be a less preferred embodiment of the present invention.

The Fiscal Agent deducts (111a) certain charges from the subscription proceeds as permitted under the Offering Memorandum and Subscription Agreement, ultimately depositing the net proceeds into the designated Reserve Account where the funds are held until the earlier of substitution of the Temporary Global Certificates with the definitive Investment Units or the close of the Reserve Period (which, for the purposes of this example, is the same as the term of the Temporary Global Certificates). The Fiscal Agent notifies (111b) the Underwriter/Guarantor that the subscription proceeds have been cleared and approved and are then on deposit in the Reserve Account. The Fiscal Agent also, as may be necessary, confirms that the Underwriter/Guarantor is granted a first position on the accounts of the Issuer as established and maintained at the Fiscal Agent's institution in the event of default or a call for payment under the Guarantee to be issued.

The Underwriter/Guarantor is engaged for the issuance of a letter of credit in support of the Fiscal Agent's undertaking to repurchase the financial instruments pursuant to the Repurchase Agreement. The letter of credit is preferably organized as a standby letter of credit which becomes available for draw by the Fiscal Agent in the event that the Fiscal Agent requires further financial support for its repurchase of the financial instruments at the Investment Term as agreed (“Repurchase Guarantee” or “Guarantee”). Upon the Issuer's identification and readying of its initial investments during the term of the Reserve Period or any permitted extension thereof, the Issuer causes (112) instruction to be given to the Underwriter/Guarantor calling for the issuance and delivery of the Repurchase Guarantee to a safekeeping account established at the Fiscal Agent's institution for the purposes of accepting and holding the Guarantee(s) on behalf of the Subscribers/Investors (“Custodial Account”). The delivery of the Repurchase Guarantee to the Custodial Account directly guarantees the Fiscal Agent's repurchase of the financial instruments at the conclusion of the Investment Term as set forth in the Repurchase Agreement.

The Underwriter/Guarantor causes (113) the issuance of the Repurchase Guarantee(s) in accordance with the aforementioned issuance profile for face value equal to the par value of the outstanding financial instruments (in accordance with the terms of the Repurchase Agreement), unless it has been otherwise agreed with the Subscribers/Investors that the face value of the Repurchase Guarantee may be discounted. The Guarantee(s) is delivered by the Underwriter/Guarantor to the Fiscal Agent. The Fiscal Agent issues and delivers (114) Investment Units in favor of the Subscribers/Investors accompanied by a receipt issued by the Fiscal Agent which identifies deposits of the requisite Repurchase Guarantees to the Custodial Account (“Custodial Safekeeping Receipt”). The issuance of the Custodial Safekeeping Receipt evidences the proper deposit of the Repurchase Guarantee(s) in support of the Repurchase Agreement. Upon delivery (115) of the Investment Units and any additional documentation appertaining thereto, the Fiscal Agent has exercised the Issuer's right of substitution of the definitive Investment Units for the Temporary Global Certificates on behalf of the Issuer, and the Subscriber/Investor immediately surrenders the Temporary Global Certificates to the Fiscal Agent.

Against the delivery of the Investment Units, funds are (116) freely available on the Reserve Account for subsequent withdrawal and investment by the Issuer. As the means of administering investment draws by the Issuer, the Fiscal Agent creates a non-interest bearing, depository account at the Fiscal Agent's institution designated for the deposit and disbursement of subscription proceeds in favor of a certain investment as identified, selected and scheduled by the Issuer (“Investment Account”). Deposits into the Investment Account permit the timely and documented withdrawals of proceeds in support of the Issuer's commencement of its scheduled investments. By way of example and not limitation, such investments may include any SSB approved, Shari'ah compliant investment operation or project, including, but not limited to energy markets, equipment leasing, real estate, manufacturing, securitized mortgages and warehousing. The Issuer (by instruction to the Fiscal Agent) draws (117) upon investment proceeds deposited to the Investment Account from the Reserve Account for direct and specific application by the Issuer to certain scheduled investments that constitute a portion of the investment portfolio. The Issuer selects and affects (118) the scheduled investments in accordance with the investment eligibility requirements set forth in the Offering Memorandum. Over the course of the Investment Term, any earnings on the investments, respectively, are (119) paid in or otherwise collected by the Issuer pursuant to the specific terms of investment applicable to a given project or company which is, was or became the intended application or use of the proceeds derived from the sale of the Investment Units (“Investment”) in support of a calculation and declaration of yield on the Investment Units.

The Issuer makes (120) a declaration of composite yield, if any, for the Investments during the scheduled period(s) during the Investment Term for which yield, if any, is calculated and payable (“Payment Period”). Any such yield payment is remitted in favor of a non-interest bearing, depository account at the Fiscal Agent's institution designated for the receipt and acceptance of yield payments from the Issuer (“Yield Account”). Funds deposited to the Yield Account will be subsequently disbursed via a non-interest bearing, depository account at the Fiscal Agent's institution designated for the deposit and immediate disbursement of all payments due to the Subscribers/Investors under or in relation to the Investment Units (“Payment Account”). On the scheduled period(s) during the Investment Term for which yield, if any, is calculated and payable (“Payment Date”), the Fiscal Agent disburses (121) from the Payment Account any declared yield payment from the Issuer related to the Investment portfolio's performance during a given Payment Period in favor of the Subscribers/Investors pursuant to instructions received.

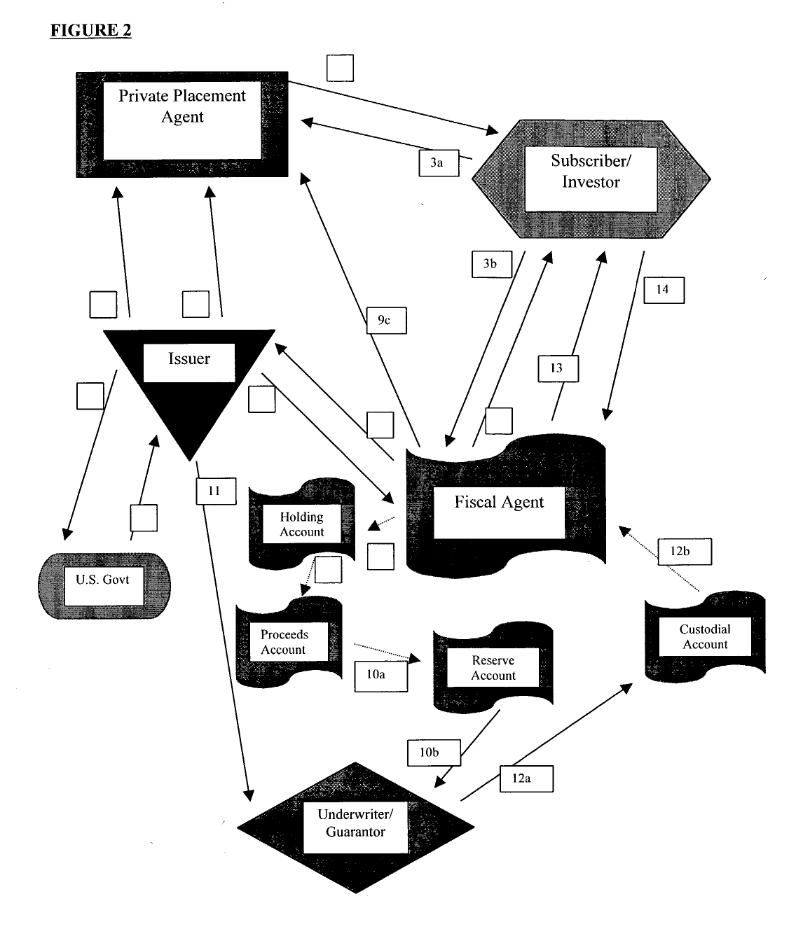

Referring now to FIG. 2, a methodological schematic showing details of a subscription process in accordance with the principles of the present invention is seen. The Offering Memorandum and all supporting documentation is (201) tendered by the Issuer to the Private Placement Agent for placement with qualified investors. The Private Placement Agent markets (202) the Offering to qualified investors via the use of the Offering Memorandum and/or select related documentation. The Subscriber/Investor provides (203a) advice of reservation for Investment Units to the Private Placement Agent, inclusive of quantities of Investment Units desired for purchase upon issuance. The Subscriber/Investor executes and delivers (203b) the Subscription Agreement and corresponding funds origin warranties to the Fiscal Agent, accompanied by a deposit of proposed investment proceeds to the designated Holding Account at the Fiscal Agent's institution.

An original copy of the Subscription Agreement and attachments are (204) provided to the Issuer by the Fiscal Agent for the purposes of the Issuer's evaluation and consideration of the Subscriber/Investor. The Issuer advises (205) the applicable United States Government agency of the proposed subscription to be made by a given Subscriber/Investor, seeking affirmation of the political and economic good standing of the proposed Subscriber/Investor. Provided the United States Government does not take issue with the quality or participation of a Subscriber/Investor, the Issuer receives (206) governmental consent to accept the subscription/investment proceeds and sell the Investment Units to the Subscriber/Investor.

Within a predefined period of receipt of subscription proceeds to the Holding Account, the Issuer advises (207) both the Fiscal Agent and Private Placement Agent of its acceptance of the Subscriber/Investor, and delivers an executed version of the Subscription Agreement to the Fiscal Agent signifying the Issuer's approval of the Subscriber/Investor. Upon receipt of the executed Subscription Agreement, the Fiscal Agent delivers (208) the Temporary Global Certificates to the Subscriber/Investor, accompanied by the executed Subscription Agreement and all other related documents.

The Fiscal Agent deposits (209) subscription proceeds to a non-interest bearing, depository account at the Fiscal Agent's institution designated for the deposit of gross subscription proceeds upon the Issuer's approval and acceptance of the Subscriber/Investor (“Proceeds Account”). Pursuant to payment instructions and authorizations held by the Fiscal Agent, all placement related fees and other charges such as the Fiscal Agent's fee, accrued legal fees, and the Rating Agency's fee are deducted from the gross subscription proceeds as held within the Proceeds Account.

The Fiscal Agent deposits (210a) net subscription proceeds into the designated Reserve Account where the net subscription proceeds are held until the earlier of substitution of the Temporary Global Certificates or the close of the Reserve Period (which, for the purposes of this example, is the same as the term of the Temporary Global Certificates). The Fiscal Agent notifies (210b) the Underwriter/Guarantor that the subscription proceeds have been cleared and approved, and are then on deposit in the Reserve Account. The Fiscal Agent also confirms that the Guarantor is provided a first position on the accounts of the Issuer as maintained with the Fiscal Agent in the event of default or a call for payment under the Guarantee to be issued.

Upon the Issuer's identification and readying of its initial investments during the term of the Reserve Period or any permitted extension thereof, the Issuer causes (211) instruction to be given to the Underwriter/Guarantor calling for the issuance and delivery of the Repurchase Guarantee to the Custodial Account as maintained with the Fiscal Agent in support of the Fiscal Agent's repurchase of the Investment Units at the conclusion of the Investment Term as set forth in the Repurchase Agreement. The Underwriter/Guarantor causes (212) the issuance of the Repurchase Guarantee(s) for face value equal to the par value of the outstanding Investment Units (in accordance with the terms of the Repurchase Agreement), unless it has been otherwise agreed with the Subscribers/Investors that the face value of the Repurchase Guarantee may be discounted. The Guarantee(s) are delivered by the Underwriter/Guarantor to the Fiscal Agent. The Fiscal Agent issues and delivers (213) the Investment Units in favor of the Subscribers/Investors, accompanied by a Custodial Safekeeping Receipt evidencing the proper deposit of the Guarantee(s) of repurchase for the benefit of the Subscriber/Investor. Upon delivery of the Investment Units, and the Custodial Safekeeping Receipt appertaining thereto, the Fiscal Agent has (214) fully exercised the Issuer's right of substitution of the definitive Investment Units for the Temporary Global Certificates on behalf of the Issuer, and the Subscriber/Investor surrenders the Temporary Global Certificates to the Fiscal Agent.

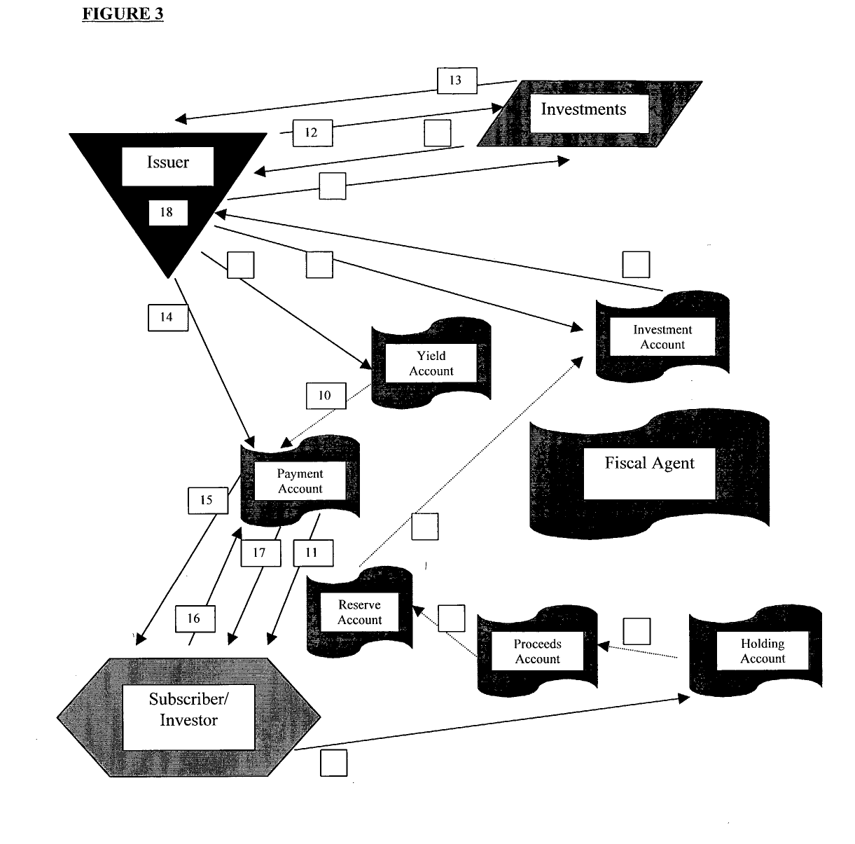

Referring now to FIG. 3, a methodological schematic showing payments, cash accounts and Investment Unit repurchase in accordance with the principles of the present invention is seen. The Subscriber/Investor submits (301) its Subscription Agreement and deposit of subscription proceeds to the Holding Account with the Fiscal Agent, pending review and approval of the Subscriber/Investor's purchase of the Investment Units by the Issuer. Upon advice of the Issuer's approval of the Subscriber/Investor, the Fiscal Agent deposits (302) subscription proceeds to the Proceeds Account, where the Fiscal Agent deducts and disburses an amount of funds from the gross subscription proceeds equal to the aggregate total of agreed placement related fees and other charges such as the Placement Agent's fee, the Fiscal Agent's fee, the Rating Agency's fee, accrued legal fees and any other charges or commissions outstanding or due.

The Fiscal Agent deposits (303) the balance of subscription proceeds (net of fees and charges deducted) to the Reserve Account where they are held in support of the redemption of the Temporary Global Certificates, pending issuance of the Investment Units prior to the close of the Reserve Period. Upon the issuance and delivery of the definitive Investment Units to the Subscribers/Investors, the Issuer instructs (304) the Fiscal Agent to deposit a specific value of the net subscription proceeds to the Investment Account for disbursement by the Fiscal Agent to enable one or more eligible investments by the Issuer. The Fiscal Agent deposits (305) funds to the Investment Account pursuant to instructions received.

The Fiscal Agent disburses (306) funds to be invested from the Investment Account (via a nominated title company or other closing facility in which the investment application and draw is to be documented) pursuant to the Issuer's direction. The Issuer implements (307) the selected eligible Investments.

During the Investment Term and subject to the generation of certain earnings or the creation of certain profits by the Investments, the earnings or profits are (308) utilized collectively to calculate the yield or dividends to be paid on the Investment Units to the Subscribers/Investors during a given Payment Period. Any dividends on the Investment Units declared by the Issuer pursuant to a dividend calculation schedule to be set forth and disclosed in the Offering Memorandum are (309) paid into the Yield Account with the Fiscal Agent.

The Fiscal Agent records (310) the dividend paid into the Yield Account and, on or before a scheduled Payment Date, deposits the yield to the Payment Account for disbursement. The Fiscal Agent disburses (311) declared dividends and/or yield to the Subscribers/Investors in full from the Payment Account.

As may be necessary prior to the conclusion of the scheduled date when the Investment Units are to be redeemed or otherwise repurchased (which also corresponds to the conclusion of the Investment Term) (“Redemption Date”), the Issuer takes (312) whatever actions are necessary to cause the sale, liquidation, refinance and/or other like action concerning the Investments in order to cover costs, payments and expenses associated with the repurchase of the Investment Units on the Redemption Date pursuant to the Repurchase Agreement as undertaken by the Fiscal Agent (as in the case of the present example) or an alternative third party, for the benefit of the Subscribers/Investors. Proceeds from the sale, liquidation, refinance or other like action related to the Investments are (313) collected by the Issuer.

On or about the close of the Investment Term or Redemption Date of the Investment Units, the Issuer deposits (314) funds sufficient to cover the cost of repurchase of the Investment Units into the Payment Account with the Fiscal Agent. Upon receipt of sufficient repurchase proceeds into the Payment Account, the Fiscal Agent (315) instructs the Subscribers/Investors' to present or surrender the Investment Units being repurchased at the counters of the Fiscal Agent for payment. The Subscribers/Investors surrender (316) the Investment Units to the Fiscal Agent. The Fiscal Agent makes (317) full payment from the Payment Account to the Subscribers/Investors for the Investment Units pursuant to the terms of the Repurchase Agreement. The Issuer subsequently takes (318) possession of the Investment Units from the Fiscal Agent based upon Issuer's payment to the Fiscal Agent of an amount equal to the cost of repurchase of the Investment Units by the Fiscal Agent, and the obligation of the Issuer related to the Investment Units is ended.

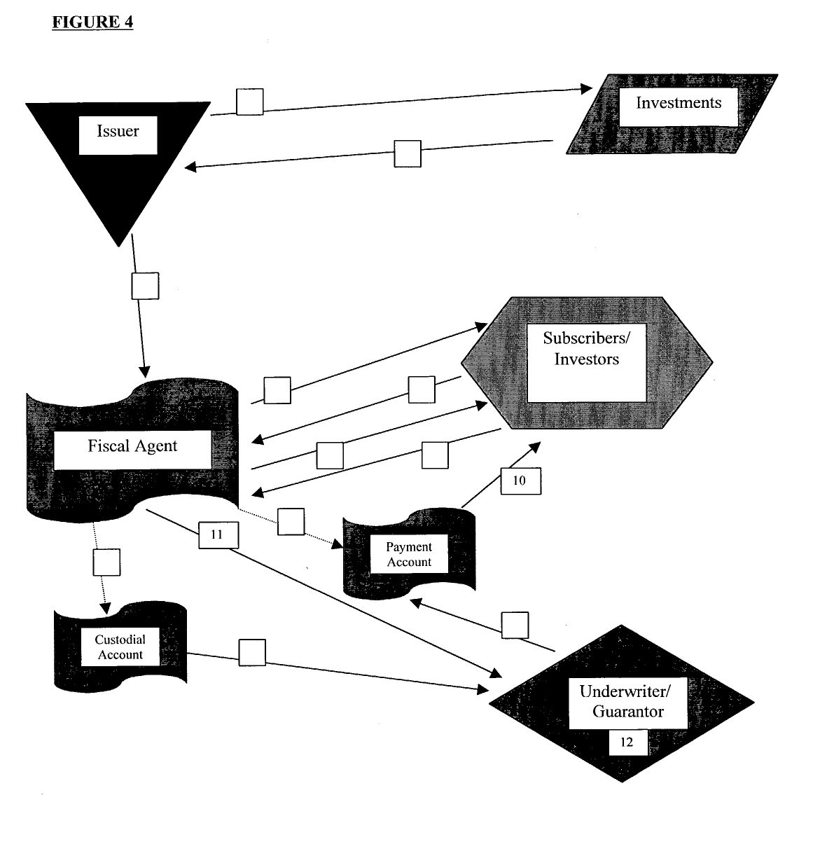

Referring now to FIG. 4, a methodological schematic showing repurchase via utilization of the Guarantee in accordance with the principles of the present invention is seen. As necessary prior to the conclusion of the Investment Term/Redemption Date of the Investment Units, the Issuer takes (401) whatever actions necessary to cause the sale, liquidation, refinance and/or other like action concerning the Investments in order to reimburse or otherwise cover costs, payments and expenses associated with the Fiscal Agent's repurchase of the Investment Units on the Redemption Date pursuant to the Repurchase Agreement as executed for the benefit of the Subscribers/Investors. Proceeds from the sale, liquidation, refinance or other like action related to the Investments are (402) collected by the Issuer, if any. In the event that proceeds collected from the Investments are insufficient to reimburse the full cost of repurchase of the Investment Units, on or about the close of the Investment Term or Redemption Date of the Investment Units, the Issuer notifies (403) the Fiscal Agent of any such short-fall, and deposits any available proceeds collected into the Payment Account with the Fiscal Agent. Upon receipt of notice and any available payment from the Issuer, the Fiscal Agent advises (404) the Subscribers/Investors accordingly.

At the Fiscal Agent's option, (405) the Fiscal Agent shall call for payment under the terms and conditions of the Guarantee to cover all or the outstanding balance of the Investment Unit repurchase cost or expense. The Fiscal Agent, on behalf of the Subscribers/Investors presents (406) its demand for payment to the Underwriter/Guarantor pursuant to the terms and conditions of the Guarantee. Provided the Fiscal Agent has presented its demand in compliance with the Guarantee, the Underwriter/Guarantor makes (407) payment to the Payment Account with the Fiscal Agent.

Upon receipt of repurchase/redemption proceeds derived from the Guarantee into the Payment Account, the Fiscal Agent advises (408) the Subscribers/Investors of the deposit of the funds and instructs the Subscribers/Investors' presentation or surrender of the Investment Units being repurchased at the counters of the Fiscal Agent for payment/purchase. The Subscribers/Investors surrender (409) the Investment Units to the Fiscal Agent. The Fiscal Agent makes (410) full payment from the Payment Account to the Subscribers/Investors for the Investment Units pursuant to the instructions of the Subscribers/Investors.

The Fiscal Agent, if required, delivers (411) the Investment Units as surrendered by the Subscribers/Investors to the Underwriter/Guarantor or pursuant to instructions received. The Underwriter/Guarantor takes (412) whatever actions it deems necessary concerning the Issuer and its accounts to offset payments made under the Guarantee.

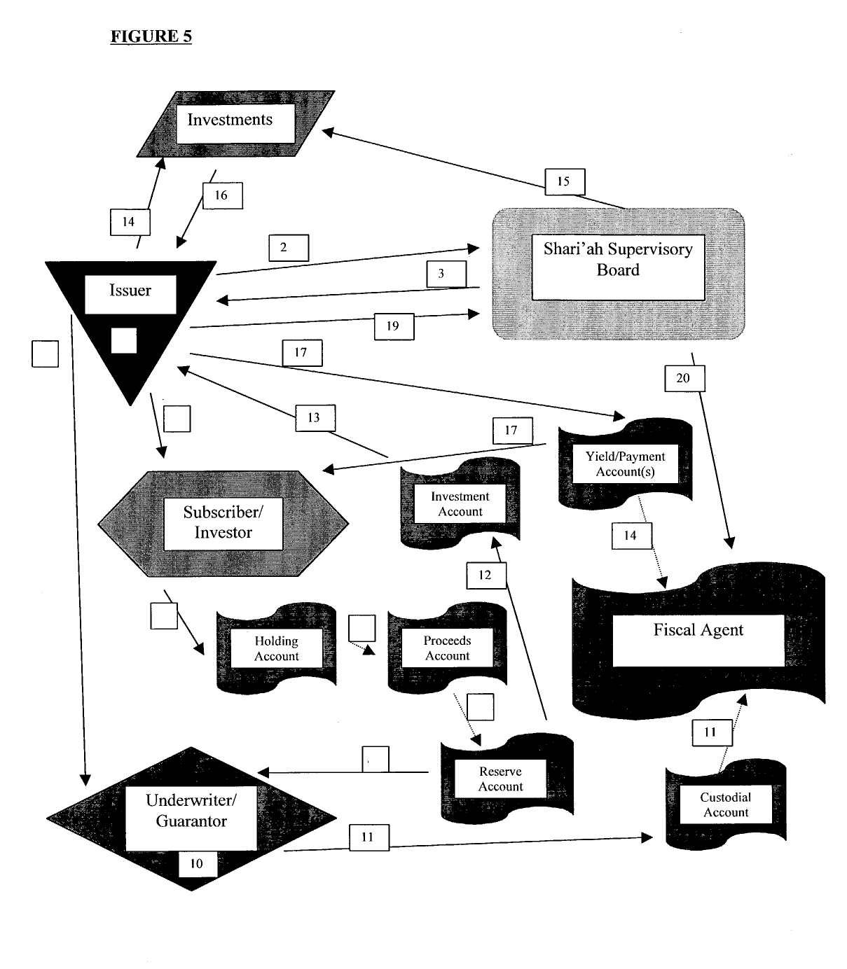

Referring now to FIG. 5, a methodological schematic showing Shari'ah compliant mechanisms in accordance with the principles of the present invention is seen. The Issuer assembles (501) a Shari'ah Supervisory Board consisting of a minimum of two and a maximum of three recognized, qualified and duly certified Islamic Scholars and, at the option of the Issuer, an expert in the Issuer's business operation to supervise, monitor and advise as to all matters of Islamic compliance involving the Issuer's issuance and sale of the Investment Units, on-going operations, and financial interests concerning the calculation and payment of yield, financial risk management, and the underwriting and repurchase of the Investment Units at the conclusion of the Investment Term.

The Issuer provides (502) to the Shari'ah Supervisory Board the Offering Memorandum for the series of Investment Units to be issued, all related and supporting documentation pertaining to the issuance of the Investment Units, and documentation related to the operations of the Issuer's business and/or the eligibility criteria pertaining to the Investments. The Shari'ah Supervisory Board reviews (503) all documentation and data provided by the Issuer and, providing all is compliant, issues its certification of compliance with Shari'ah investment and financial principles which is incorporated into the Offering Memorandum and related documentation by the Issuer.

The Issuer (via the Private Placement Agent) provides (504) the Offering Memorandum and related documentation to certain qualified, candidate Subscribers/Investors who are likely of Islamic belief and practice. In conjunction with the execution of the Subscription Agreement, the Subscriber/Investor deposits (505) its funds for the acquisition of the Investment Units into the non-interest bearing Holding Account with the Fiscal Agent and awaits review and approval of its proposed subscription by the Issuer.

Upon the Issuer's acceptance of the Subscriber/Investor, the Fiscal Agent transfers (506) the gross subscription proceeds into a non-interest bearing Proceeds Account and deducts and disburses an amount of funds from the subscription proceeds sufficient to pay all placement related fees and other charges such as the Fiscal Agent's fee, accrued legal fees, the Rating Agency Fee and any other commissions payable. The Fiscal Agent thereafter deposits (507) the subscription proceeds, net of all fees, into a Shari'ah compliant investment or non-interest bearing Reserve Account with the Fiscal Agent where funds remain on deposit until the earlier of either the date of substitution of the Investment Units for the Temporary Global Certificates by the Fiscal Agent, or the conclusion of the Reserve Period which, for the purposes of this example, corresponds to the date of redemption of the Temporary Global Certificates. Alternatively, the Issuer may instruct and the Fiscal Agent to permit the transfer of net subscription proceeds from the Proceeds Account with the Fiscal Agent to a Shari'ah compliant investment account or non-interest bearing account with the Underwriter/Guarantor banking institution where funds would remain on deposit to be managed by the Underwriter/Guarantor until the earlier of either the date of substitution of the Investment Units for the Temporary Global Certificates by the Fiscal Agent, or the conclusion of the Reserve Period which, for the purposes of this example, corresponds to the date of redemption of the Temporary Global Certificates.

The Fiscal Agent confirms (508) deposit of the subscription proceeds on the Reserve Account to the Underwriter/Guarantor while also confirming the Underwriter/Guarantor's security interest in the Issuer's accounts as maintained with the Fiscal Agent upon the Underwriter/Guarantor's issuance and delivery of the Guarantee and a demand for payment against the Guarantee. Alternatively, the net subscription proceeds are already on a Shari'ah compliant account with the Underwriter/Guarantor, available for management and possible attachment in the event of a demand for payment under the Guarantee. Prior to the conclusion of the Reserve Period, the Issuer issues (509) instruction to the Underwriter/Guarantor to cause the issuance of the Guarantee in support of the Repurchase Agreement.

The Underwriter/Guarantor does not charge (510) an issuance fee (“Issuance Fee”) for the Guarantee. In order for the Guarantee to be and remain Shari'ah compliant, the Underwriter/Guarantor must agree to waive the collection of Issuance Fees related to the Guarantee; the Underwriter/Guarantor instead can potentially profit by discounting the face value of the Guarantee or by way of other potential revenue centers available to it related to the operations of the Issuer.

The Underwriter/Guarantor issues and delivers (511) a Guarantee to the Fiscal Agent for the benefit of the Subscribers/Investors in the form of a letter of credit, preferably a standby letter of credit, payable in support of the full and timely satisfaction of the terms of the Repurchase Agreement. Upon receipt of the Guarantee(s), the Fiscal Agent causes the issuance and delivery of the definitive Investment Units (constituting a full substitution for the Temporary Global Certificates then held by the Subscribers/Investors), and, upon specific instruction/advice from the Issuer, authorizes and causes (512) the deposit of an amount of funds (required to affect one or more certain Investment(s) by the Issuer) from the Reserve Account to the Investment Account, a non-interest bearing account.

Pursuant to instruction received from the Issuer, the Fiscal Agent disburses (513) that portion of subscription proceeds from the Investment Account via a title, escrow or other like entity in favor of the Issuer's designated Investments. The Issuer authorizes and affects (514) the disbursement of funds into the selected Investment via appropriately auditable channels, thus assuring that the Investment meets with the eligibility criteria established in the Offering Memorandum as such was approved by the Shari'ah Supervisory Board.

During the Investment Term, the Shari'ah Supervisory Board periodically audits and randomly inspects (515) the operations of the Investments to assure that no portion of the operations of the Investments fail to comply with Shari'ah Investment Guidelines and business principles. Over the course of the Investment Term, any earnings on the investments, respectively, are (516) paid in or otherwise collected by the Issuer pursuant to the specific terms of investment applicable to a given Investment in support of a calculation and declaration of yield on the Investment Units. No interest or similar specific charges are payable by the Investments to the Issuers, except in cases in which Shari'ah compliant loans may have been established from time-to-time.

The Issuer makes (517) a declaration of composite yield, if any, for the Investments during each designated Payment Period of the Investment Units and remits any such yield payment in favor of the non-interest bearing Yield Account for disbursement via the non-interest bearing Payment Account, each of which is maintained with the Fiscal Agent. There is no guarantee of a specific yield, earnings or interest payable to the Subscriber/Investor in relation to the Investment Units or the Investments. On the applicable Payment Date, the Fiscal Agent disburses (518) any declared yield payment from the Payment Account related to the Investments' performance during a given Payment Period in favor of the Subscribers/Investors pursuant to instructions received.

Annually and no later than a given number of days following the anniversary of the date of issuance of the Investment Units during the Investment Term, the Issuer delivers (519) a copy of its annual report and financial data to the Shari'ah Supervisory Board for inspection and annual Shari'ah re-certification of the Investments and the Investment Units. The Shari'ah Supervisory Board reviews and audits the operations of the Issuer, Investments and the Fiscal Agent as necessary to obtain sufficient information to issue their collective Shari'ah certification. Against a satisfactory audit and inspection of the documents delivered by the Issuer, the Shari'ah Supervisory Board delivers (520) a copy of their updated Shari'ah certification to the Fiscal Agent where copies of same are made available to and for the records of the Subscribers/Investors throughout the balance of the Investment Term.

Thus, a financial instrument in accordance with the principles of the present invention which has been set forth and described herein encompasses certain specific features which make it new and innovative in the global capital markets. First and foremost, a financial instrument in accordance with the principles of the present invention makes tangible the philosophical beliefs of Islam within a framework which is conducive to traditional Western financial thought. This marriage of ideologies is evident via the overlay of financial practices generally identified in FIG. 5, which demonstrates Shari'ah compliant mechanisms within traditional capital markets, thus creating a bridge between the financial cultures which is elegant in its philosophical simplicity yet poignant in its ability to simplify that which is by nature a seemingly complex set of religiously founded investment principles.

While the invention has been described with specific embodiments, other alternatives, modifications and variations will be apparent to those skilled in the art. Accordingly, it will be intended to include all such alternatives, modifications and variations set forth within the spirit and scope of the appended claims.

### Glossary of Terms

Auditing and Accounting Office of Islamic Financial Institutions “AAOIFI”): responsible for, among other things, the monitoring and oversight of Islamic banking and investment institutions.

Auditor: The firm to be appointed should specialize in matters of Islamic finance. It should afford the Issuer with a comprehensive and Shari'ah compliant accounting body upon which the Shari'ah Supervisory Board and the investors may place reliance.

Custodial Account: a safekeeping account established at the Fiscal Agent's institution for the purposes of accepting and holding the Repurchase Guarantee(s) for the ultimate benefit of the Subscribers/Investors.

Custodial Safekeeping Receipt: the receipt issued by the Fiscal Agent which identifies deposits to the Custodial Account of the Guarantee(s).

Fiscal Agent: a substantial international banking institution having a credit agency rating of sufficient quality to meet minimal rating criteria set forth by the nominated credit rating agency which rates the Investment Units; acts as the administrator for the issuance of the Investment Units and paying agent on behalf of the Issuer in favour of the Investors.

Guarantee: the letter of credit, preferably a standby letter of credit, which is issued by the Underwriter/Guarantor in support of the repurchase of the Investment Units.

Holding Account: a non-interest bearing, depository account at the Fiscal Agent's institution designated for the receipt of proposed subscription proceeds prior to the Subscriber/Investor having been accepted by the Issuer for purchase of the Investment Units.

Investment: the project or company which is, was or became the intended application or use of the proceeds derived from the sale of the Investment Units.

Investment Account a non-interest bearing, depository account at the Fiscal Agent's institution designated for the deposit and disbursement of subscription proceeds in favor of a certain investment as identified, selected and scheduled by the Issuer.

Investment Term: the term of the Investment Units, or that period between the date of subscription and the scheduled date of redemption of the Investment Units.

Investment Unit: the Shari'ah (Islamic) compliant investment-grade security to be issued and sold resultant from the application of a financial instrument in accordance with the principles of the present invention.

Issuance Fee: the fee customarily charged by a banking institution or other such entity for the issuance of a letter of credit or other similar undertaking.

Issuer: the entity which issues the Investment Units, makes the Offering for the purpose of attracting investment and subsequently manages and implements the proceeds of the sale of the Investment Units in a manner consistent with the investment criteria established related to that certain Offering for which the Investment Units were issued.

Offering: the means by which the Investment Units are made available for purchase to the investment marketplace by the Private Placement Agent or Issuer.

Offering Memorandum: the document which provides the potential investor with a required description of and disclosure related to the nature of the Investment Units being offered for sale.

Payment Account: a non-interest bearing, depository account at the Fiscal Agent's institution designated for the deposit and immediate disbursement of all payments due to Subscribers/Investors under or in relation to the Investment Units.

Payment Date: the scheduled dates as defined in the terms and conditions of the Investment Units for payment of yield, if any, on the Investment Units.

Payment Period: the scheduled period(s) during the Investment Term for which yield, if any, is calculated and payable.

Private Placement Agent: the entity which is expressly responsible for the marketing of the Offering on behalf of the Issuer and which benefits from a close association with the Islamic investment market.

Proceeds Account: a non-interest bearing, depository account at the Fiscal Agent's institution designated for the deposit of subscription proceeds upon the Issuer's approval and acceptance of the Subscriber/Investor and from which all placement related fees and other charges may be deducted.

Rating Agency: Moody's Investor Services, Standard & Poors, or such other internationally recognized credit rating agency.

Redemption Date: the scheduled date when the Investment Units are to be redeemed or otherwise repurchased; also corresponds to the conclusion of the Investment Term.

Reserve Account: a non-interest bearing, depository account or Shari'ah compliant investment account at the Fiscal Agent's or Underwriter/Guarantor's institution designated for the reservation and holding of funds during the Reserve Period while the Temporary Global Certificates remain outstanding, prior to the issuance of the definitive Investment Units.

Reserve Period: that period of time while subscription proceeds are held in the Reserve Account in support of the Temporary Global Certificates.

Repurchase Agreement: the terms and conditions under which the repurchase of the Investment Units from the Subscriber/Investors by the Fiscal Agent or, as the case may be, an alternative third party, is scheduled at an agreed value and on a future date certain.

Repurchase Guarantee: See “Guarantee”.

Shari'ah Supervisory Board: an advisory board consisting of at least two Islamic Scholars and an expert in the field of endeavor of the Issuer/Investment, alternatively, it may consist of three Islamic Scholars and still meet the auditing requirements of the AAOIFI. The SSB reviews the Issuer's proposed Investment Unit issuance and underlying investment/business strategy and is responsible for the monitoring of the Issuer's operations and the issuance of requisite certifications as to Shari'ah (Islamic) investment compliance throughout the life of Investment Unit series.

Subscribers/Investors: those entities, parties or individuals who purchase the Investment Units, consisting of Islamic institutional investors (primarily banking and financial institutions), Islamic investment management funds, high net worth Islamic individuals and trusts and, to a lesser extent, non-Islamic investors.

Subscription Agreement: the agreement which defines the terms and conditions of the subscription of and investment in the Investment Units by the Subscriber/Investor.

Subscription Proceeds: the funds denominated in United States Dollars which were derived from the sale of the Investment Units to the Subscribers/Investors.

Temporary Global Certificates: the temporary certificates issued in favour of the Subscriber/Investors during the Reserve Period prior to the issuance of the definitive Investment Units by the Issuer;

Underwriter/Guarantor: This entity may consist of several international banking institutions, insurers or functionally comparable entities; however, in general there is a lead underwriting institution of sufficient credit quality (its credit rating according to S & P or Moody's) to meet minimal rating criteria set forth by the nominated credit rating agency which subsequently rates the Investment Units. The Underwriter/Guarantor is engaged for the purposes of issuance of its guarantee in support of the repurchase of the Investment Units at the close of the Investment Term.

Yield Account: a non-interest bearing, depository account at the Fiscal Agent's institution designated for the receipt and acceptance of yield payments from the Issuer.

What is claimed is:

1. The method of creating a financial instrument comprising:
creating or nominating an entity which issues financial instruments;
assembling a Shari'ah Supervisory Board;
reviewing the proposed financial instrument as to Shari'ah (Islamic) investment compliance;
securing a rating of the financial instruments by a credit rating agency;
providing the financial instrument to certain qualified, candidate subscribers who may be of Islamic belief and practice;
issuing a guarantee for the benefit of the subscribers payable in the event of default; and
monitoring the financial instruments as to Shari'ah (Islamic) investment compliance.

2. The method of creating a financial instrument of claim 1, wherein the step of assembling a Shari'ah Supervisory Board further includes assembling a minimum of two and a maximum of three recognized, qualified and duly certified Islamic scholars.

3. The method of creating a financial instrument of claim 2, wherein the step of assembling a Shari'ah Supervisory Board further includes including an expert in the Issuer's business operation.

4. The method of creating a financial instrument of claim 1, wherein the step of reviewing the proposed financial instrument as to Shari'ah (Islamic) investment compliance further includes providing to the Shari'ah Supervisory Board documents which provide the potential investor with a required description of and disclosure related to the nature of the financial products being offered for sale and documentation related to the operations of the Issuer's business and/or the eligibility criteria pertaining to investments.

5. The method of creating a financial instrument of claim 1, wherein the Shari'ah Supervisory Board further includes supervising, monitoring and advising as to matters of Islamic compliance involving the Issuer's issuance and sale of the financial products, ongoing operations, and financial interests concerning the calculation and payment of yield, financial risk management, and the underwriting of the financial products.

6. The method of creating a financial instrument of claim 1, wherein after the step of reviewing the proposed financial instrument as to Shari'ah (Islamic) investment compliance the Shari'ah Supervisory Board issuing a certification of compliance with Shari'ah investment and financial principles.

7. The method of creating a financial instrument of claim 1, wherein the step of rating the financial instruments by a credit rating agency further includes rating the financial instruments by Standard & Poor's, 55 Water Street, New York, N.Y. 10041 (“S&P”), Moody's Investors Service, Inc., 99 Church Street, New York, N.Y. 10007 (“Moody's”) or such other recognized credit rating agency acceptable to investors.

8. The method of creating a financial instrument of claim 1, wherein the step of issuing a guarantee for the benefit of the subscribers further includes issuing a letter of credit.

9. The method of creating a financial instrument of claim 1, further wherein an issuance fee is not charged for the guarantee.

10. The method of creating a financial instrument of claim 9, wherein the step of not charging an issuance fee further includes making fees and charges effectively payable in the event that the guarantee is called for payment.

11. The method of creating a financial instrument of claim 9, wherein the step of not charging an issuance fee further includes offsetting any declined issuance fees with bank fees and charges customarily payable related to funds under management.

12. The method of creating a financial instrument of claim 9, wherein the step of not charging an issuance fee for the guarantee further includes discounting the face value of the guarantee to offset fees and charges associated therewith and entering into independent Shari'ah compliant management agreements for funds on deposit.

13. The method of creating a financial instrument of claim 9, wherein the step of not charging an issuance fee for the guarantee further includes offsetting any declined issuance fees and charges with compensating balances and funds (other than those arising from subscription proceeds) on deposit under Shari'ah compliant management agreements.

14. The method of creating a financial instrument of claim 1, wherein the step of issuing a guarantee for the benefit of the subscribers further includes supporting the repurchase of the financial instruments at an agreed price at the close of the investment term via the issuance of its third party guarantee.

15. The method of creating a financial instrument of claim 1, wherein the step of issuing a guarantee for the benefit of the subscribers further includes causing the issuance of the guarantee for face value equal to the par value of the investment units, unless a discount thereof is otherwise agreed.

16. The method of creating a financial instrument of claim 1, further including providing a first position on funds and/or assets of the issuer in the event of a default or a call of the guarantee to the guarantor.

17. The method of creating a financial instrument of claim 1, further including delivering the guarantee to a custodial safekeeping account for the purposes of accepting and holding the guarantee.

18. The method of creating a financial instrument of claim 1, further wherein the step of monitoring as to Shari'ah (Islamic) investment compliance further includes periodically auditing and randomly inspecting operations to assure that no portion of the operations fail to comply with Shari'ah Investment Guidelines and business principles.

19. The method of creating a financial instrument of claim 1, further wherein the step of monitoring as to Shari'ah (Islamic) investment compliance further includes delivering a copy of an annual report and financial data to the Shari'ah Supervisory Board for inspection.

20. The method of creating a financial instrument of claim 1, further wherein the step of monitoring as to Shari'ah (Islamic) investment compliance further includes making a copy of an updated Shari'ah certification available to and for the records of the Subscribers.

21. The method of creating a financial instrument comprising:
depositing funds for the acquisition of the financial instrument from that subscriber into a non-interest bearing, depository account designated for subscription proceeds;
following receipt of sufficient proposed subscription proceeds, depositing funds for the acquisition of the financial instrument into a non-interest bearing, depository reserve account or Shari'ah compliant investment account designated for the reservation and holding of funds;
issuing temporary certificates in favor of the subscribers which secure and represent subscription proceeds prior to the issuance of the financial instruments;
issuing a guarantee for the benefit of the subscribers payable in the event of default;
upon receipt of the guarantee, substituting investment units for the temporary certificates then held by the Subscribers/Investors.

22. The method of creating a financial instrument of claim 21 further wherein the step of depositing funds for the acquisition of the financial instrument from that subscriber into a non-interest bearing, depository account designated for subscription proceeds further comprises:
prior to acceptance of a subscriber, depositing funds for the acquisition of the financial instrument from that subscriber into a non-interest bearing, depository holding account designated for the receipt of proposed subscription proceeds; and
after acceptance of a subscriber, transferring funds for the acquisition of the financial instrument from the holding account into a non-interest bearing, depository proceeds account designated for the deposit of subscription proceeds.

23. The method of creating a financial instrument of claim 21 further including creating a non-interest bearing, depository investment account designated for the deposit and disbursement of subscription proceeds in favor of a certain investment; and transferring an amount of funds required to affect a certain investment from the reserve account to the investment account.

24. The method of creating a financial instrument of claim 23 further including drawing upon investment proceeds deposited to the investment account for direct and specific application to certain investments.

25. The method of creating a financial instrument of claim 24, further wherein the step of drawing upon investment proceeds deposited to the Investment Account for direct and specific application to certain investments further includes disbursing that portion of subscription proceeds from the investment account via a title, escrow or other like entity in favor of the Issuer's designated Investments.

26. The method of creating a financial instrument of claim 24, further wherein the step of drawing upon investment proceeds deposited to the investment account for direct and specific application to certain investments further includes affecting the disbursement of funds into selected investments via appropriately auditable channels, thus assuring that the investment meets with the eligibility criteria established and approved by the Shari'ah Supervisory Board.

27. The method of creating a financial instrument of claim 21, wherein the step of depositing funds into the reserve account further includes holding funds in the reserve account until the earlier of substitution of the temporary certificates or the close of the term of the temporary certificates.

28. The method of creating a financial instrument of claim 21, wherein the step of depositing funds into the reserve account further includes holding funds in the reserve account in support of the redemption of the temporary certificates.

29. The method of creating a financial instrument of claim 21 further including assembling a Shari'ah Supervisory Board and reviewing the proposed financial instrument as to Shari'ah (Islamic) investment compliance.

30. The method of creating a financial instrument of claim 29, wherein the step of assembling a Shari'ah Supervisory Board further includes assembling a minimum of two and a maximum of three recognized, qualified and duly certified Islamic Scholars.

31. The method of creating a financial instrument of claim 30, wherein the step of assembling a Shari'ah Supervisory Board further includes including an expert in the area of the Issuer's business operation.

32. The method of creating a financial instrument of claim 29, wherein the step of reviewing the proposed financial instrument as to Shari'ah (Islamic) investment compliance further includes providing to the Shari'ah Supervisory Board documents which provide the potential investor with a required description of and disclosure related to the nature of the financial products being offered for sale and documentation related to the operations of the Issuer's business and/or the eligibility criteria pertaining to investments.

33. The method of creating a financial instrument of claim 29, wherein the Shari'ah Supervisory Board further includes supervising, monitoring and advising as to matters of Islamic compliance involving the Issuer's issuance and sale of the financial products, on-going operations, and financial interests concerning the calculation and payment of yield, financial risk management, and the underwriting of the financial products.

34. The method of creating a financial instrument of claim 29, wherein after the step of reviewing the proposed financial instrument as to Shari'ah (Islamic) investment compliance the Shari'ah Supervisory Board issues a certification of compliance with Shari'ah investment and financial principles.

35. The method of creating a financial instrument of claim 21 further including securing a rating of the financial instruments by a credit rating agency.

36. The method of creating a financial instrument of claim 35, wherein the step of rating the financial instruments by a credit rating agency further includes rating the financial instruments by Standard & Poor's, 55 Water Street, New York, N.Y. 10041 (“S&P”), Moody's Investors Service, Inc., 99 Church Street, New York, N.Y. 10007 (“Moody's”) or some other recognized and acceptable rating agency.

37. The method of creating a financial instrument of claim 35, wherein the step of rating the financial instruments by a credit rating agency further includes an evaluation of the guarantee as the primary source of credit enhancement in support of the rating.

38. The method of creating a financial instrument of claim 21 further including monitoring as to Shari'ah (Islamic) investment compliance throughout the life of the financial instruments.

39. The method of creating a financial instrument of claim 38, further wherein the step of monitoring as to Shari'ah (Islamic) investment compliance further includes periodically auditing and randomly inspecting operations to assure that no portion of the operations fail to comply with Shari'ah Investment Guidelines and business principles.

40. The method of creating a financial instrument of claim 38, further wherein the step of monitoring as to Shari'ah (Islamic) investment compliance further includes delivering a copy of an annual report and financial data to the Shari'ah Supervisory Board for inspection.

41. The method of creating a financial instrument of claim 38, further wherein the step of monitoring as to Shari'ah (Islamic) investment compliance further includes making a copy of an updated Shari'ah certification available to and for the records of the Subscribers.

42. The method of creating a financial instrument of claim 21 further including remitting yield payments in favor of a non-interest bearing, depository yield account designated for the receipt and acceptance of yield payments.

43. The method of creating a financial instrument of claim 42 further including transferring the funds in the yield account to a non-interest bearing, depository payment account designated for the deposit and immediate disbursement of all payments due to the subscribers.

44. The method of creating a financial instrument of claim 42, further including transferring and depositing funds sufficient to cover the cost of repurchase into the payment account.

45. The method of creating a financial instrument of claim 21 further including in the event that proceeds collected from the Investments are insufficient to cover the full cost of repurchase of the Investment Units, calling the guarantee to cover the repurchase.

46. The method of creating a financial instrument of claim 21, wherein the step of issuing a guarantee for the benefit of the subscribers further includes issuing a letter of credit which becomes available for draw in support of the repurchase of the Investment Units.

47. The method of creating a financial instrument of claim 46, wherein the step of issuing a guarantee for the benefit of the subscribers further includes issuing a standby letter of credit.

48. The method of creating a financial instrument of claim 21, further wherein an issuance fee is not charged for the guarantee.

49. The method of creating a financial instrument of claim 48, wherein the step of not charging an issuance fee further includes making fees and charges effectively payable in the event that the guarantee is called for payment.

50. The method of creating a financial instrument of claim 48, wherein the step of not charging an issuance fee further includes offsetting any declined issuance fees with bank fees and charges customarily payable related to funds under management.

51. The method of creating a financial instrument of claim 48, wherein the step of not charging an issuance fee for the guarantee further includes discounting the face value of the guarantee to offset fees and charges associated therewith and entering into independent Shari'ah compliant management agreements for funds on deposit.

52. The method of creating a financial instrument of claim 48, wherein the step of not charging an issuance fee for the guarantee further includes offsetting any declined issuance fees and charges with compensating balances and funds (other than those arising from subscription proceeds) on deposit under Shari'ah compliant management agreements.

53. The method of creating a financial instrument of claim 21, wherein the step of issuing a guarantee for the benefit of the subscribers further includes supporting the repurchase value of the financial instruments at the close of the term via the issuance of its third party guarantee.

54. The method of creating a financial instrument of claim 21, wherein the step of issuing a guarantee for the benefit of the subscribers further includes causing the issuance of the guarantee for face value equal to the par value of the financial instruments, unless otherwise agreed for discount.

55. The method of creating a financial instrument of claim 21, further including providing a first position on the accounts or assets of the issuer in the event of a default or a call of the guarantee to the guarantor.

56. The method of creating a financial instrument comprising:
creating or nominating an entity which issues financial instruments;
securing a rating of the financial instruments by a credit rating agency;
issuing a guarantee for the benefit of subscribers payable in the event of default;
monitoring as to Shari'ah (Islamic) investment compliance;
causing the sale, liquidation, refinance and/or other like action concerning investments in order to cover costs, payments and expenses associated with the repurchase of the financial instruments from the subscribers; and
in the event that proceeds collected from the Investments are insufficient to reimburse or otherwise cover the full cost of repurchase, calling for payment under the guarantee.

57. The method of creating a financial instrument of claim 56, wherein the step of monitoring as to Shari'ah (Islamic) investment compliance further includes assembling a Shari'ah Supervisory Board.

58. The method of creating a financial instrument of claim 57, wherein the step of assembling a Shari'ah Supervisory Board further includes assembling a minimum of two and a maximum of three recognized, qualified and duly certified Islamic Scholars.

59. The method of creating a financial instrument of claim 58, wherein the step of assembling a Shari'ah Supervisory Board further includes including an expert in the Issuer's business operation.

60. The method of creating a financial instrument of claim 57, further including the Shari'ah Supervisory Board reviewing the proposed financial instrument and related offering documentation as to Shari'ah (Islamic) investment compliance.

61. The method of creating a financial instrument of claim 56, further wherein the step of monitoring as to Shari'ah (Islamic) investment compliance further includes periodically auditing and randomly inspecting operations and investments to assure that no portion of the operations fail to comply with Shari'ah Investment Guidelines and business principles.

62. The method of creating a financial instrument of claim 56, further wherein the step of monitoring as to Shari'ah (Islamic) investment compliance further includes delivering a copy of an annual report and financial data to the Shari'ah Supervisory Board for inspection.

63. The method of creating a financial instrument of claim 56, further wherein the step of monitoring as to Shari'ah (Islamic) investment compliance further includes making a copy of an updated Shari'ah certification available to and for the records of the Subscribers.

64. The method of creating a financial instrument of claim 56, wherein the step of issuing a guarantee for the benefit of the subscribers further includes issuing a letter of credit.

65. The method of creating a financial instrument of claim 56, further wherein an issuance fee is not charged for the guarantee.

66. The method of creating a financial instrument of claim 65, wherein the step of not charging an issuance fee further includes making fees and charges effectively payable in the event that the guarantee is called for payment.

67. The method of creating a financial instrument of claim 65, wherein the step of not charging an issuance fee further includes offsetting any declined issuance fees with bank fees and charges customarily payable related to funds under management.

68. The method of creating a financial instrument of claim 65, wherein the step of not charging an issuance fee for the guarantee further includes discounting the face value of the guarantee to offset fees and charges associated therewith and entering into independent Shari'ah compliant management agreements for funds on deposit.

69. The method of creating a financial instrument of claim 65, wherein the step of not charging an issuance fee for the guarantee further includes offsetting any declined issuance fees and charges with compensating balances and funds (other than those arising from subscription proceeds) on deposit under Shari'ah compliant management agreements.

70. A financial instrument comprising:
an investment vehicle which complies with Shari'ah investment guidelines;
the investment vehicle effectuating a passive or semi-passive investment by an individual or institution which observes Islamic law in the establishment of its investment criteria and the implementation of its investment practices; and
the investment vehicle qualifying as investment-grade, ratable securities within a capital markets environment.

71. A financial instrument comprising:
a traditional, rated, investment grade security in compliance with Shari'ah investment guidelines and Islamic law.
